(19) United States
(12) Patent Application Publication
(10) Pub. No.: US 2004/0223472 A1
(43) Pub. Date: Nov. 11, 2004

(54) Data randomization in a wireless communication system

(76) Inventors: Sundar G. Sankaran, San Jose, CA (US); Mitchell D. Trott, Mountain View, CA (US); Paul Petrus, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/791,458

(22) Filed: Mar. 1, 2004

Related U.S. Application Data
(60) Provisional application No. 60/453,110, filed on Mar. 6, 2003.

(51) Int. Cl. H04B 7/216

(52) U.S. Cl. 370/335

(57) ABSTRACT

In one embodiment of the present invention, a receiver can only properly receive signals that were intended for the receiver because the data descrambling depends on the identity of the receiver. In one embodiment, the invention is a communication device including a data source containing data to be transmitted to a remote radio, and a randomizer to scramble the data using an identifier related to the remote radio. In one embodiment, at least a part of the identifier related to the remote radio is used as at least part of a seed of the randomizer.

### PRIORITY AND RELATED APPLICATIONS

The present patent application claims the priority benefit of the Provisional Patent Application No. 60/453,110 filed Mar. 6, 2003, which is incorporated herein by reference.

### BACKGROUND OF THE INVENTION

1. Field of the Invention

The present invention applies to the field of data coding and modulation and, in particular, to data randomization in a wireless communication system.

2. Description of the Prior Art

Digital devices, such as computers and various digital communications equipment, store and process data as binary digits, also known as bits. A bit is either zero or one (“0” or “1”). All digital information, such as mp3 files, jpeg images, text files, DVD movies, and so on are stored as a collection of bits.

Such digital data is transferred over a communications medium by being modulated onto a carrier signal, which is then propagated through some medium, such as a wire or the ether. In the case of wireless communications, the carrier signal is some frequency band of electromagnetic radiation. Most data communications systems use radio waves.

There are numerous techniques for modulating binary data onto a radio signal. The first step is to map the binary data to modulation symbols, which are then used to modulate the appropriate carrier wave or waves. When non-random information-bearing data is modulated onto a carrier, the power distribution of the signal tends to be uneven, with large peaks and valleys in the transmitted signal. One way to decrease such interference causing power surges is to randomize the data to be transmitted at the transmitter using a pseudo-random sequence. The receiver can use the same sequence to de-scramble the received bits and retrieve the data.

### BRIEF SUMMARY OF THE INVENTION

In one embodiment of the present invention, a receiver can only properly receive signals that were intended for the receiver because the data descrambling depends on the identity of the receiver. In one embodiment, the invention is a communication device including a data source containing data to be transmitted to a remote radio, and a randomizer to scramble the data using an identifier related to the remote radio. In one embodiment, at least a part of the identifier related to the remote radio is used as at least part of a seed of the randomizer.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is a simplified diagram of an example wireless communications network suitable for implementing various embodiments of the present invention;

FIG. 2A is a simplified block diagram of an example transmitter suitable for implementing various embodiments of the present invention;

FIG. 2B is a simplified block diagram of an example receiver suitable for implementing various embodiments of the present invention;

FIG. 3 is a simplified block diagram of a data randomizer according to an embodiment of the present invention;

FIG. 4 is a simplified block diagram of an initialization vector according to one embodiment of the present invention;

FIG. 5 is a simplified block diagram of a base station on which an embodiment of the invention can be implemented; and

FIG. 6 is a simplified block diagram of a remote terminal on which an embodiment of the invention can be implemented.

### DETAILED DESCRIPTION OF THE INVENTION

According to one embodiment of the invention, bursts are randomized using a scrambling sequence generator seeded at least in part with a part of a connection identifier (CID). In other embodiments, a part of the registration identifier (RID) can be used for the seed. The seed can also include parts of the base station identifier (BSID) or color code (BSCC) and the absolute frame number (AFN).

Wireless Communications System

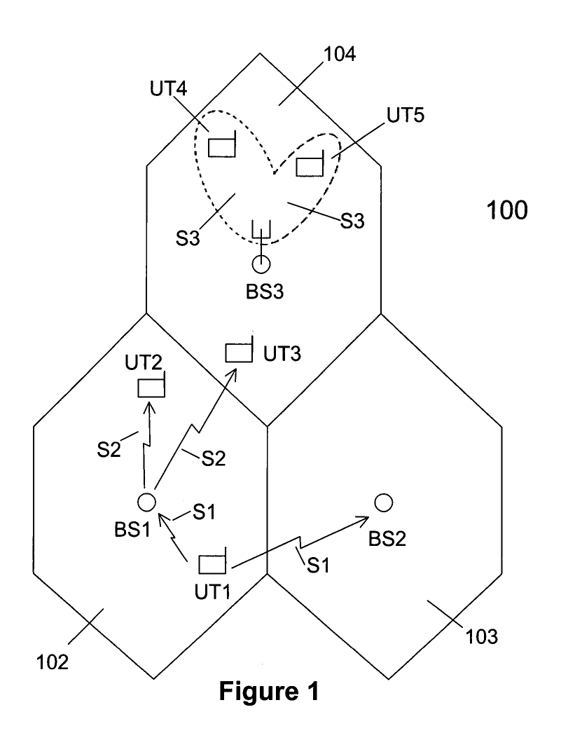

FIG. 1 illustrates an example wireless communication system 100 in which embodiments of the present invention can be implemented. For simplicity, only three cells—cell 102 serviced by base station BS1, cell 103 serviced by base station BS2, and cell 104 serviced by base station BS3—are shown. In a wireless system 100, user terminals—such as user terminals UT1-UT5—access a network (not shown) by communicating wirelessly with the base stations.

On the uplink, the signal from a user terminal may be received by more than one base station. For example, in FIG. 1, signal S1 from UT1 to BS1 is also received by BS2. If BS2 successfully demodulates and receives the signal S1 it may become confused. One solution can be for UT1 to identify itself and the base station it is communicating with in every burst. This would consume significant overhead.

On the downlink, the signal from a base station may be received by more than one user terminal. For example, in FIG. 1, UT2 is in cell 102 but close to the border of cell 104, and UT3 is in cell 104 but close to the border of cell 102, and cell 102 and 104 use the same frequency band as a carrier. Thus, the signal S2 from BS1 to UT2 is also received by UT3. If UT3 correctly demodulates the signal S2 it will cause confusion as data not meant for UT3 will have been inserted into UT3's received data stream.

A similar problem can arise on the downlink if a base station is using spatial division multiple access (SDMA). For example, in FIG. 1, BS3 is using the same conventional channel to communicate with user terminals UT4 and UT5, directing signal S3 towards user terminal UT4 while attempting to place a null to UT5. However, sometimes the null placing fails and UT5 also received the signal S3 meant for user terminal UT4. As noted above in the uplink case, these problems related to the downlink can be addressed by including the identifier of the target user terminal in each burst or signal. However, this has a significant overhead cost, since it uses potential data bits for user terminal identification.

Example Receiver and Transmitter

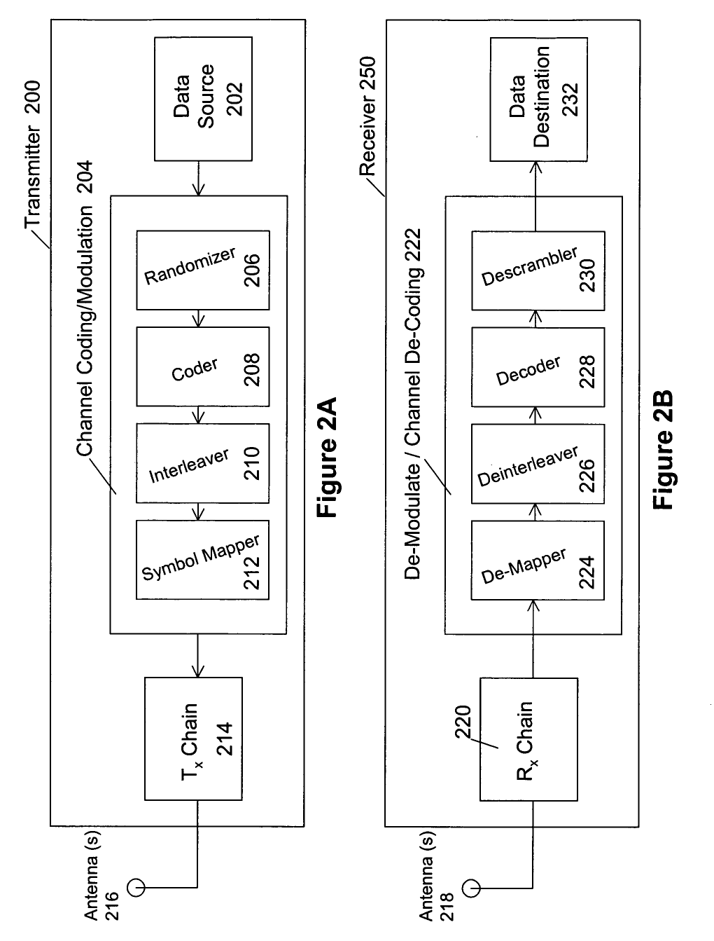

FIG. 2A and 2B illustrate a radio transmitter 200 and receiver 250 that can be used for some embodiments of the present invention. The transmitter 200 includes a data source 202, i.e., the data to be transmitted. For example, if the transmitter 200 is a user terminal, the data source can be the data originating on the device the terminal is providing connectivity for. For example, the device may be a laptop computer, and the data source 202 can be a file on the laptop computer that a user wants to communicate over the wireless network. If the transmitter 200 is a base station, then the data source 202 can be a file requested by a user terminal from the Internet being channeled through the base station, or any other data.

The data 202 then goes through channel coding and modulation 204. In one embodiment, the data is first randomized 206, so that it looks random. Next the data is coded 208, for example for error correction using a Reed-Solomon or Hamming encoder. The data can then be interleaved 210 so that errors are spread out over the burst, as that can make such errors easier to correct. And finally, the data is then mapped 212 into modulation symbols. The modulation symbols are used by the transmit chain 214 to modulate a carrier which is transmitted in a burst over to ether from the antenna 216 or an antenna array. The burst is received by the receiver antenna(s) 218 and the receive chain 220, where it is demodulated 224 from symbols to bits, de-interleaved 226, decoded 228, and descrambled 230. The resulting received data is then delivered to the data destination 232.

The transmitter and receiver shown in FIGS. 2A and 2B represent merely one possible configuration. The components within the channel coding/modulation 204 and demodulation/channel decoding 222 blocks can be reorganized in numerous other sequences. For example, FIG. 2A shown randomization 206 to take place on the bit level. However, randomization 206 can also take place on the symbol level. In this case, the data would pass through the modulation symbol mapping block 212 prior to the randomization block 206.

The Randomizer

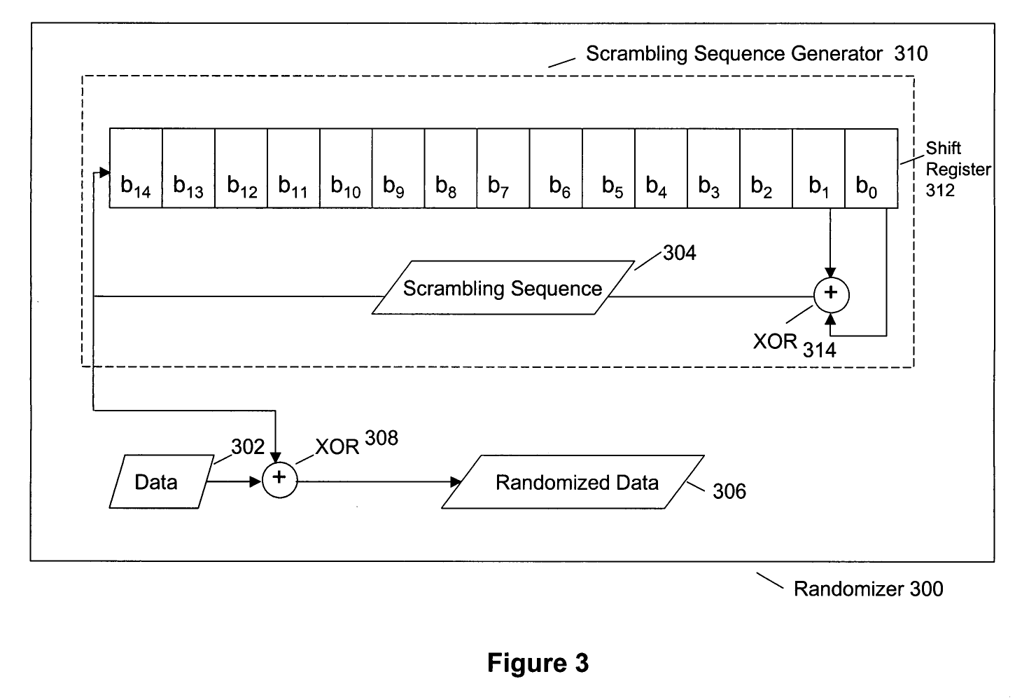

One embodiment of a randomizer module is now illustrated with reference to FIG. 3. This randomizer 300 works on the bit level. Data 302 enters the randomizer as a bit stream where it is combined with a pseudo-random scrambling sequence 304 to create the randomized data 306. In one embodiment, the scrambling sequence 304 is also a bit stream that is bitwise exclusive or-ed (XOR 308) with the data bit stream 302.

In one embodiment, the scrambling sequence generator 310 is made up of a shift register 312 and XOR 314. In the scrambling sequence generator 310 shown on FIG. 3, the two least significant bits in the shift register 312—bits b₁and b₀—are XOR-ed to produce the next bit of the scrambling sequence 304. This new bit is also inserted in the most significant bit position, i.e., bit 14, and all the bits are shifted one to the left. Repeating this operation produces a pseudo-random scrambling sequence 304. The initial values in the shift register are referred to as the “seed” or “initialization vector” of the scrambling sequence generator 310 or the randomizer 300.

There are many other ways to implement the scrambling sequence generator 310. For example, the shift register 312 is not limited to 15 bits, but can have any number of bits large enough to produce a pseudo-random sequence. Furthermore, any two bits can be XOR-ed to produce the sequence, not just the two least significant bits. Furthermore, the present invention is not limited to using shift registers and XOR operations. Any manner of generating a pseudo-random sequence from a seed is within the scope of the present invention.

Furthermore, the randomizer 300 need not operate on the bit level, but can operate on the modulation symbol level. Symbols are generally represented as complex numbers. The scrambling sequence 304 can be used to implement various shifts, rotations, reflections, and conjugations on the symbols. Alternatively the sequence 304 can be converted into symbols and combined with the data symbols on the symbol level. The embodiments of the present invention are not limited to any specific operation of the randomizer 300. Rather, the present invention is applicable to any randomizer, since all randomizers must be initialized.

Initialization Vectors

As mentioned above, the initial value of the randomizer is called the “seed” or the “initialization vector.” The seed is made up of all the initial bits in the shift register, or other pseudo-random sequence generating mechanism. For example, a seed for the shift register 312 in FIG. 3 would be 15 bits long. The seed must be a value that is known—or can be regenerated—at both the transmitter and the receiver, since the receiver must descramble the data using the same, or mathematically related, sequence.

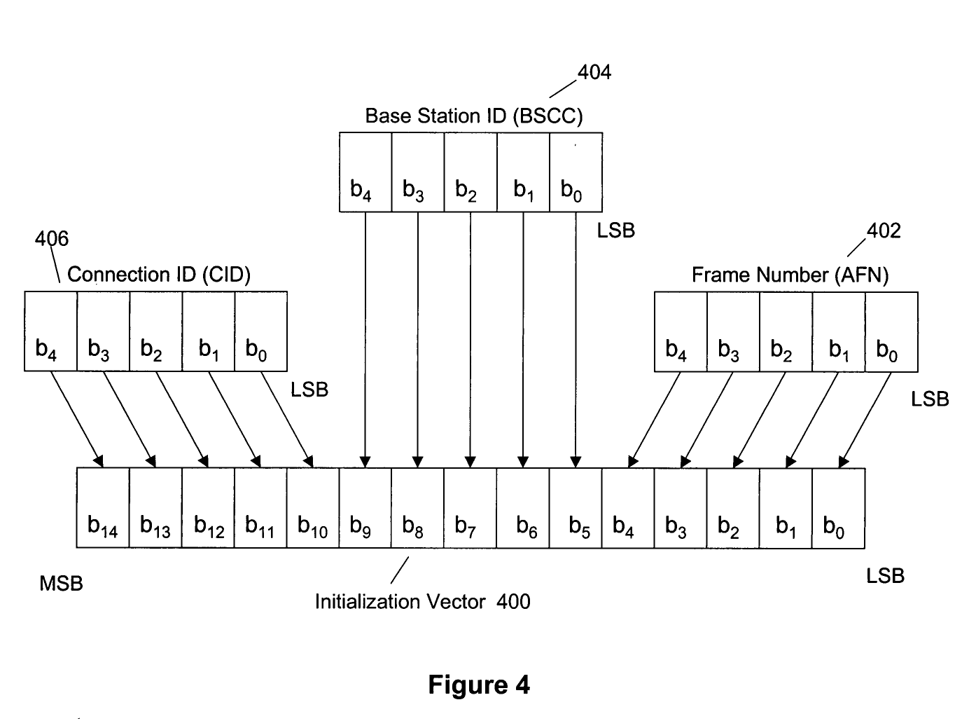

One embodiment of the present invention is now described with reference to FIG. 4. FIG. 4 illustrates a 15-bit initialization vector 400, and the various values used to create it. The five least significant bits of the seed 400 are taken from the frame number, referred to as the absolute frame number (AFN) in some systems. Since the frame number is generally longer than five bits in a real life system, some concatenation—such as the five least significant bits—can be used. One benefit of using the frame number in the scrambling is that retries of the same data burst will be scrambled differently, thereby creating a different randomized output and hence a different error behavior.

The middle five bits of the seed 400 are taken from the base station identifier 404 (BS1D), also referred to as the base station color code (BSCC) in some systems. In one embodiment, the BSCC uniquely identifies each base station within the system. In other embodiments, multiple base stations can share a BSCC so long as they are out of each others potential range; e.g., base stations in different cities can have the same BSCC. In other words, in this embodiment, the BSCC is locally unique. Once again, since the BSCC can be longer than five bits in some real life systems, some concatenation—such as the five least significant bits—can be used.

One benefit of including the BSCC in the scrambling, is that base stations can use this information to separate uplink bursts that are meant for them versus those that are not. Referring again to FIG. 1, the signal S1 from user terminal UT1 is received by both base stations BS1 and BS2. In one embodiment, if the base stations descramble using their base station identifiers, i.e., the BSCC, only base station BS1 will properly receive the signal S1, since the user terminal UT1 randomized the signal using the BSCC of BS1, the base station that UT1 is communicating with. BS2 will descramble the received signal using its own BSCC, and will thus introduce numerous errors into the decoded data. This in turn will cause the error detection mechanism—such as the cyclic redundancy check (CRC)—to fail, resulting in the received signal being discarded.

The most significant five bits of the seed 400 are taken from the connection identifier 406 (CID). In one embodiment, the CID uniquely identifies a connection—such as a flow or a session—between a base station and user terminal pair. Once again, since the CID can be longer than five bits in some real life systems, some concatenation—such as the five least significant bits—can be used.

One benefit of including the CID in the scrambling, is that the user terminals can use this information to separate downlink bursts that are meant for them versus those that are not. Referring again to FIG. 1, the signals S2 and S3 are both received by at least one user terminal for which they are not meant (UT3 and UT5 respectively). In one embodiment, if the user terminals descramble using the CID used for their particular connection, only user terminal UT2 will properly receive the signal S2 and only user terminal UT4 will properly receive the signal S3. User terminals UT3 and UT5 will not correctly decode the bursts they received, and they will be discarded.

The values used to create the initialization vector 400 shown in FIG. 4 represent only one of many embodiments of the present invention. For example, any identifier related to the user terminal can be used instead of the CID 406. In one embodiment, the registration identifier (RID) is used, i.e., the identifier of the registration of the user terminal with the base station during which the scrambled burst is transmitted. Other identifiers related to the user terminal that can be used can be a system-wide unique user terminal identifier (UTID), the MAC address of the user terminal, or any other such identifier related to the user terminal. The chosen identifier can be concatenated as necessary depending on the number of bits it introduces into the seed 400.

Similarly, the base station identifier (BS1D) or base station color code (BSCC) are only two possible base station-related identifiers that can be used to create the initialization vector 400. Any identifier associated with the base station can be used in accordance with some embodiments of the present invention.

Furthermore, some embodiments of the present invention only use an identifier related to the user terminal to create the seed 400, while other embodiments only use an identifier related to the base station. Yet others, such as the example shown in FIG. 4 use both.

In one embodiment of the present invention, the elements used to create the scrambling seed also change depending on the type of signal or burst being transmitted. For example, a broadcast signal cannot be scrambled with the RID of a user terminal, since all user terminals need to receive the broadcast signal. Similarly, the broadcast signal does not include the AFN in some systems to save bandwidth. In this case, the user terminal configuration request burst also cannot be scrambled using the AFN since the user terminal does not yet know it. In one embodiment, the scrambling seed changes based on how much information is available at the base station and the user terminal. One such embodiment is illustrated with reference to Table 1:

TABLE 1

| Burst Type | Seed Created Using: | Payload Information |
|---|---|---|
| Broadcast | No Scrambling | BSCC |
| Configuration Request | BSCC | UTID |
| Configuration Message | BSCC (and/or UTID) | AFN |
| Random Access | BSCC, AFN | RID |
| Access Assignment | BSCC, AFN, RID | |
| Traffic-Uplink | BSCC, AFN, RID | |
| Traffic-Downlink | BSCC, AFN, RID | |

Base Station Structure

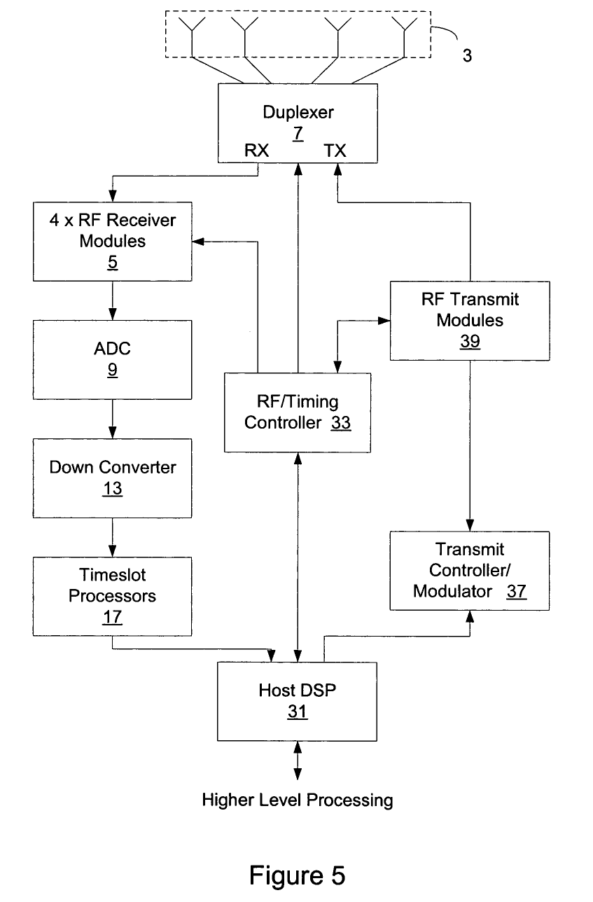

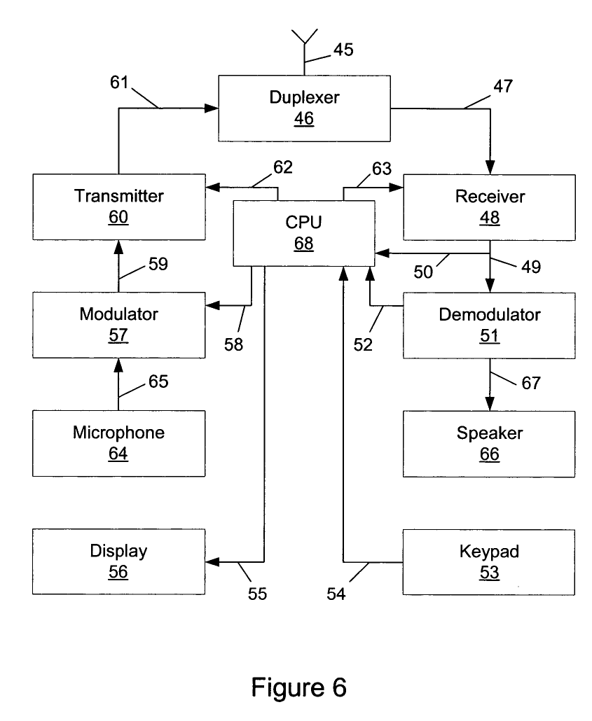

The data randomization described above can be used in any communications system. FIG. 5 shows an example of a base station of a wireless communications system or network suitable for implementing the present invention. The system or network includes a number of subscriber stations, also referred to as remote terminals or user terminals, such as that shown in FIG. 6. The base station may be connected to a wide area network (WAN) through its host DSP 31 for providing any required data services and connections external to the immediate wireless system. To support spatial diversity, a plurality of antennas 3 is used, for example four antennas, although other numbers of antennas may be selected.

A set of spatial multiplexing weights for each subscriber station are applied to the respective modulated signals to produce spatially multiplexed signals to be transmitted by the bank of four antennas. The host DSP 31 produces and maintains spatial signatures for each subscriber station for each conventional channel and calculates spatial multiplexing and demultiplexing weights using received signal measurements. In this manner, the signals from the current active subscriber stations, some of which may be active on the same conventional channel, are separated and interference and noise suppressed. When communicating from the base station to the subscriber stations, an optimized multi-lobe antenna radiation pattern tailored to the current active subscriber station connections and interference situation is created. Suitable smart antenna technologies for achieving such a spatially directed beam are described, for example, in U.S. Pat. No. 5,828,658, issued Oct. 27, 1998 to Ottersten et al. and U.S. Pat. No. 5,642,353, issued Jun. 24, 1997 to Roy, III et al. The channels used may be partitioned in any manner. In one embodiment the channels used may be partitioned as defined in the GSM (Global System for Mobile Communications) air interface, or any other time division air interface protocol, such as Digital Cellular, PCS (Personal Communication System), PHS (Personal Handyphone System) or WLL (Wireless Local Loop). Alternatively, continuous analog or CDMA channels can be used.

The outputs of the antennas are connected to a duplexer switch 7, which in a TDD embodiment, may be a time switch. Two possible implementations of the duplexer switch are as a frequency duplexer in a frequency division duplex (FDD) system, and as a time switch in a time division duplex (TDD) system. When receiving, the antenna outputs are connected via the duplexer switch to a receiver 5, and are converted down in analog by RF receiver (“RX”) modules 5 from the carrier frequency to an FM intermediate frequency (“IF”). This signal then is digitized (sampled) by analog to digital converters (“ADCs”) 9. Final down-converting to baseband is carried out digitally. Digital filters can be used to implement the down-converting and the digital filtering, the latter using finite impulse response (FIR) filtering techniques. This is shown as block 13. The invention can be adapted to suit a wide variety of RF and IF carrier frequencies and bands.

There are, in the present example, eight down-converted outputs from each antenna's digital filter 13, one per receive timeslot. The particular number of timeslots can be varied to suit network needs. While GSM uses eight uplink and eight downlink timeslots for each TDMA frame, desirable results can also be achieved with any number of TDMA timeslots for the uplink and downlink in each frame. For each of the eight receive timeslots, the four down-converted outputs from the four antennas are fed to a digital signal processor (DSP) 17 (hereinafter “timeslot processor”) for further processing, including calibration, according to one aspect of this invention. Eight Motorola DSP56300 Family DSPs can be used as timeslot processors, one per receive timeslot. The timeslot processors 17 monitor the received signal power and estimate the frequency offset and time alignment. They also determine smart antenna weights for each antenna element. These are used in the SDMA scheme to determine a signal from a particular remote user and to demodulate the determined signal.

The output of the timeslot processors 17 is demodulated burst data for each of the eight receive timeslots. This data is sent to the host DSP processor 31 whose main function is to control all elements of the system and interface with the higher level processing, which is the processing which deals with what signals are required for communications in all the different control and service communication channels defined in the system's communication protocol. The host DSP 31 can be a Motorola DSP56300 Family DSP. In addition, timeslot processors send the determined receive weights for each user terminal to the host DSP 31. The host DSP 31 maintains state and timing information, receives uplink burst data from the timeslot processors 17, and programs the timeslot processors 17. In addition it decrypts, descrambles, checks error correcting code, and deconstructs bursts of the uplink signals, then formats the uplink signals to be sent for higher level processing in other parts of the base station. Furthermore DSP 31 may include a memory element to store data, instructions, or hopping functions or sequences. Alternatively, the base station may have a separate memory element or have access to an auxiliary memory element. With respect to the other parts of the base station it formats service data and traffic data for further higher processing in the base station, receives downlink messages and traffic data from the other parts of the base station, processes the downlink bursts and formats and sends the downlink bursts to a transmit controller/modulator, shown as 37. The host DSP also manages programming of other components of the base station including the transmit controller/modulator 37 and the RF timing controller shown as 33.

The RF timing controller 33 interfaces with the RF system, shown as block 45 and also produces a number of timing signals that are used by both the RF system and the modem. The RF controller 33 reads and transmits power monitoring and control values, controls the duplexer 7 and receives timing parameters and other settings for each burst from the host DSP 31.

The transmit controller/modulator 37, receives transmit data from the host DSP 31. The transmit controller uses this data to produce analog IF outputs which are sent to the RF transmitter (TX) modules 35. Specifically, the received data bits are converted into a complex modulated signal, up-converted to an IF frequency, sampled, multiplied by transmit weights obtained from host DSP 31, and converted via digital to analog converters (“DACs”) which are part of transmit controller/modulator 37 to analog transmit waveforms. The analog waveforms are sent to the transmit modules 35. The transmit modules 35 up-convert the signals to the transmission frequency and amplify the signals. The amplified transmission signal outputs are sent to antennas 3 via the duplexer/time switch 7.

User Terminal Structure

FIG. 6 depicts an example component arrangement in a remote terminal that provides data or voice communication. The remote terminal's antenna 45 is connected to a duplexer 46 to permit the antenna 45 to be used for both transmission and reception. The antenna can be omni-directional or directional. For optimal performance, the antenna can be made up of multiple elements and employ spatial processing as discussed above for the base station. In an alternate embodiment, separate receive and transmit antennas are used eliminating the need for the duplexer 46. In another alternate embodiment, where time division duplexing is used, a transmit/receive (TR) switch can be used instead of a duplexer as is well known in the art. The duplexer output 47 serves as input to a receiver 48. The receiver 48 produces a down-converted signal 49, which is the input to a demodulator 51. A demodulated received sound or voice signal 67 is input to a speaker 66.

The remote terminal has a corresponding transmit chain in which data or voice to be transmitted is modulated in a modulator 57. The modulated signal to be transmitted 59, output by the modulator 57, is up-converted and amplified by a transmitter 60, producing a transmitter output signal 61. The transmitter output 61 is then input to the duplexer 46 for transmission by the antenna 45.

The demodulated received data 52 is supplied to a remote terminal central processing unit 68 (CPU) as is received data before demodulation 50. The remote terminal CPU 68 can be implemented with a standard DSP (digital signal processor) device such as a Motorola series 56300 Family DSP. This DSP can also perform the functions of the demodulator 51 and the modulator 57. The remote terminal CPU 68 controls the receiver through line 63, the transmitter through line 62, the demodulator through line 52 and the modulator through line 58. It also communicates with a keyboard 53 through line 54 and a display 56 through line 55. A microphone 64 and speaker 66 are connected through the modulator 57 and the demodulator 51 through lines 65 and 66, respectively for a voice communications remote terminal. In another embodiment, the microphone and speaker are also in direct communication with the CPU to provide voice or data communications. Furthermore remote terminal CPU 68 may also include a memory element to store data, instructions, and hopping functions or sequences. Alternatively, the remote terminal may have a separate memory element or have access to an auxiliary memory element.

In one embodiment, the speaker 66, and the microphone 64 are replaced or augmented by digital interfaces well-known in the art that allow data to be transmitted to and from an external data processing device (for example, a computer). In one embodiment, the remote terminal's CPU is coupled to a standard digital interface such as a PCMCIA interface to an external computer and the display, keyboard, microphone and speaker are a part of the external computer. The remote terminal's CPU 68 communicates with these components through the digital interface and the external computer's controller. For data only communications, the microphone and speaker can be deleted. For voice only communications, the keyboard and display can be deleted.

General Matters

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps. The steps of the present invention may be performed by hardware components, such as those shown in FIGS. 2A, 2B, 5 and 6, or may be embodied in machine-executable instructions, which may be used to cause a general-purpose or special-purpose processor or logic circuits programmed with the instructions to perform the steps. Alternatively, the steps may be performed by a combination of hardware and software. The steps have been described as being performed by either the base station or the user terminal. However, many of the steps described as being performed by the base station may be performed by the user terminal and vice versa. Furthermore, the invention is equally applicable to systems in which terminals communicate with each other without either one being designated as a base station, a user terminal, a remote terminal or a subscriber station. Thus, the present invention is equally applicable and useful in a peer-to-peer wireless network of communications devices using spatial processing. These devices may be cellular phones, PDA's, laptop computers, or any other wireless devices. Generally, since both the base stations and the terminals use radio waves, these communications devices of wireless communications networks may be generally referred to as radios.

In portions of the description above, only the base station is described as performing spatial processing using an antenna array. However, the user terminals can also contain antenna arrays, and can also perform spatial processing both on receiving and transmitting (uplink and downlink) within the scope of the present invention.

Embodiments of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods and calculations are described in their most basic form, but steps can be added to or deleted from any of the methods and information can be added or subtracted from any of the described message signals without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

What is claimed is:

1. A method performed by a first radio, the method comprising:
receiving data from a data source to be communicated to a remote radio;
randomizing the received data using an identifier related to the remote radio.

2. The method of claim 1, wherein the first radio comprises a user terminal, the remote radio comprises a base station, and the identifier comprises a base station color code.

3. The method of claim 1, wherein the first radio comprises a base station, the remote radio comprises a user terminal, and the identifier comprises a user terminal identifier (UTID).

4. The method of claim 1, wherein the first radio comprises a base station, the remote radio comprises a user terminal, and the identifier comprises a connection identifier (CID) associated with the user terminal.

5. The method of claim 1, wherein the first radio comprises a base station, the remote radio comprises a user terminal, and the identifier comprises a registration identifier (RID) associated with the user terminal.

6. The method of claim 1, wherein randomizing the received data comprises generating a scrambling sequence using at least part of the identifier as at least a part of an initialization vector, and combining the received data with the scrambling sequence.

7. A method for randomizing data to be sent from a base station of a wireless radio network to a user terminal accessing the wireless radio network, the method comprising:
generating an initialization vector using an identifier associated with the user terminal;
seeding a scrambling sequence generator with the initialization vector; and
randomizing the data using the scrambling sequence generator.

8. The method of claim 7, wherein the identifier is associated with a connection between the user terminal and the base station.

9. The method of claim 8, wherein the connection comprises a session.

10. The method of claim 7, wherein generating the initialization vector further comprises using a second identifier associated with the base station.

11. The method of claim 7, wherein generating the initialization vector further comprises using a frame number.

12. An initialization vector to be used to initialize a randomizer of a first radio communicating with a remote radio, the initialization vector comprising:
an identifier associated with the remote radio.

13. The initialization vector of claim 12, further comprising a second identifier associated with the first radio.

14. The initialization vector of claim 12, further comprising a frame number.

15. The initialization vector of claim 12, wherein the first radio comprises a base station, the remote radio comprises a user terminal, and the identifier comprises one of a user terminal ID (UTID), connection ID (CID), registration ID (RID), session ID.

16. The initialization vector of claim 12, wherein the first radio comprises a base station, the remote radio comprises a user terminal, and the second identifier comprises one of a base station ID (BS1D), base station color code (BSCC).

17. A method for randomizing data to be sent from a user terminal to a base station of a wireless radio network, the method comprising:
generating an initialization vector using an identifier associated with the base station;
seeding a scrambling sequence generator with the initialization vector; and
randomizing the data using the scrambling sequence generator.

18. The method of claim 17, wherein generating the initialization vector further comprises using a second identifier associated with the user terminal/base station pair.

19. The method of claim 18, wherein the second identifier is associated with a connection between the user terminal and the base station.

20. The method of claim 19, wherein the connection comprises a session.

21. The method of claim 17, wherein generating the initialization vector further comprises using a frame number.

22. A method performed by a base station comprising:
broadcasting a first signal carrying a first information;
descrambling a second signal from a user terminal using the first information, the second signal carrying a second information; and
randomizing a third signal using the second information.

23. The method of claim 22, wherein randomizing the third signal further comprises using the first information.

24. The method of claim 22, wherein the first signal comprises a broadcast burst and the first information comprises a base station color code (BSCC).

25. A communications device comprising:
a data source containing data to be transmitted to a remote radio; and
a randomizer to scramble the data using an identifier related to the remote radio.

26. The communications device of claim 25, wherein the communications device comprises a user terminal, the remote radio comprises a base station, and the identifier comprises a base station color code.

27. The communications device of claim 25, wherein the communications device comprises a base station, the remote radio comprises a user terminal, and the identifier comprises a user terminal identifier (UTID).

28. The communications device of claim 25, wherein the communications device comprises a base station, the remote radio comprises a user terminal, and the identifier comprises a connection identifier (CID) associated with the user terminal.

29. The communications device of claim 25, wherein the communications device comprises a base station, the remote radio comprises a user terminal, and the identifier comprises a registration identifier (RID) associated with the user terminal.

30. The communications device of claim 25, wherein randomizer scrambles the received data by generating a scrambling sequence using at least part of the identifier as at least a part of an initialization vector, and combining the received data with the scrambling sequence.
